(19) United States
(12) Patent Application Publication
(10) Pub. No.: US 2014/0025613 A1
(43) Pub. Date: Jan. 23, 2014

(54) APPARATUS AND METHODS FOR REINFORCEMENT LEARNING IN LARGE POPULATIONS OF ARTIFICIAL SPIKING NEURONS

(71) Applicant: Filip Ponulak, San Diego, CA (US)

(72) Inventor: Filip Ponulak, San Diego, CA (US)

(21) Appl. No.: 13/554,980

(22) Filed: Jul. 20, 2012

(51) Int. Cl. G06N 3/08

(52) U.S. Cl. CPC G06N 3/08
USPC 706/25

(57) ABSTRACT

Neural network apparatus and methods for implementing reinforcement learning. In one implementation, the neural network is a spiking neural network, and the apparatus and methods may be used for example to enable an adaptive signal processing system to effect network adaptation by optimized credit assignment. In certain implementations, the credit assignment may be based on a comparison between network output and individual unit contribution. The unit contribution may be determined for example using eligibility traces that may comprise pre-synaptic and/or post-synaptic activity. In certain implementations, the unit credit may be determined using correlation between rate of change of network output and eligibility trace of the unit.

### CROSS-REFERENCE TO RELATED APPLICATIONS

This application is related to co-owned U.S. patent application Ser. No. 13/238,932 filed Sep. 21, 2011, and entitled “ADAPTIVE CRITIC APPARATUS AND METHODS”, U.S. patent application Ser. No. 13/313,826 filed Dec. 7, 2011, entitled “APPARATUS AND METHODS FOR IMPLEMENTING LEARNING FOR ANALOG AND SPIKING SIGNALS IN ARTIFICIAL NEURAL NETWORKS”, U.S. patent application Ser. No. 13/314,066 filed Dec. 7, 2011, entitled “NEURAL NETWORK APPARATUS AND METHODS FOR SIGNAL CONVERSION”, and U.S. patent application Ser. No. 13/489,280 filed Jun. 5, 2012, entitled “APPARATUS AND METHODS FOR REINFORCEMENT LEARNING IN ARTIFICIAL NEURAL NETWORKS”, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Field of the Disclosure

The present innovation relates to machine learning apparatus and methods, and more particularly, in some exemplary implementations, to computerized apparatus and methods for implementing reinforcement learning rules in artificial neural networks.

### Artificial Neural Networks

An artificial neural network (ANN) is a mathematical or computational model (which may be embodied for example in computer logic or other apparatus) that is inspired by the structure and/or functional aspects of biological neural networks. Spiking neuron networks (SNN) comprise a subset of ANN and are frequently used for implementing various learning algorithms, including reinforcement learning. A typical artificial spiking neural network may comprises a plurality of units (or nodes) linked by plurality of node-to node connections. Any given node may receive input one or more connections, also referred to as communications channels, or synaptic connections. Any given unit may further provide output to other nodes via these connections. The units providing inputs to a given unit (referred to as the post-synaptic unit), are commonly referred to as the pre-synaptic units. In a multi-layer feed-forward topology, the post-synaptic unit of one unit layer may act as the pre-synaptic unit for the subsequent layer of units.

Individual connections may be assigned, inter alia, a connection efficacy (which in general refers to a magnitude and/or probability of influence of pre-synaptic spike to firing of a post-synaptic neuron, and may comprise for example a parameter such as synaptic weight, by which one or more state variables of post synaptic unit are changed). During operation of the SNN, synaptic weights are typically adjusted using a mechanism such as e.g., spike-timing dependent plasticity (STDP) in order to implement, among other things, learning by the network. Typically, a SNN comprises an adaptive system that is configured to change its structure (e.g., the connection configuration and/or weights) based on external or internal information that flows through the network during the learning phase.

Artificial neural networks may be used to model complex relationships between inputs and outputs or to find patterns in data, where the dependency between the inputs and the outputs cannot be easily attained. Artificial neural networks may offer improved performance over conventional technologies in areas which include without limitation machine vision, pattern detection and pattern recognition, signal filtering, data segmentation, data compression, data mining, system identification and control, optimization and scheduling, and complex mapping.

### Reinforcement Learning Methods

In the general context of machine learning, the term “reinforcement learning” includes goal-oriented learning via interactions between a learning agent and the environment. At each point in time t, the learning agent performs an action y(t), and the environment generates an observation x(t) and an instantaneous cost c(t), according to some (usually unknown) dynamics. The aim of the reinforcement learning is often to discover a policy for selecting actions that minimizes some measure of a long-term cost; i.e., the expected cumulative cost.

Some existing algorithms for reinforcement or reward-based learning in spiking neural networks typically describe weight adjustment as:

$$\frac{d {w}_{ij} ( t )}{d t} = η F ( t ) {e}_{ij} ( t ) \qquad ( Eqn . 1 )$$

where:
wⱼᵢ(t) is the weight of a synaptic connection between a pre-synaptic neuron i and a post-synaptic neuron j;
η is a parameter referred to as the learning rate that scales the θ-changes enforced by learning, η can be a constant parameter or it can be a function of some other system parameters;
F(t) is a performance function that may be related to the instantaneous cost or to the cumulative cost; and
eⱼᵢ(t) is the eligibility trace, configured to characterize correlation between pre-synaptic and post-synaptic activity.

Existing learning algorithms based on Eqn. 1 are generally efficient when applied to networks comprising of a limited number of neurons (in some instances, typically 10-20 neurons). However, as the number of neurons increases, the number of input and output spikes in the network may grow geometrically, thereby making it difficult to account for effects of each individual spike on the overall network output. The performance function F(t), used by existing implementations of Eqn. 1, may become unrelated to the performance of any single neuron, and may be more reflective of the collective behavior of the whole set of neurons. As a result, the network may suffer from incorrect assignment of credit to the individual neurons causing learning slow-down (or complete cessation) as the neuron population size grows.

Based on the foregoing, there is a salient need for apparatus and methods capable of efficient implementation of reinforcement learning for large populations of neurons.

### SUMMARY

The present disclosure satisfies the foregoing needs by providing, inter alia, apparatus and methods for implementing learning in artificial neural networks.

In one aspect of the invention, a method of credit assignment for an artificial spiking network is disclosed. In one implementation, the network comprises a plurality of units, and the method includes: operating the network in accordance with reinforcement learning process capable of generating a network output; determining a credit based on relating the network output to a contribution of a unit of the plurality of units; and adjusting a learning parameter associated with the unit based at least in part on the credit. In one variant, the contribution of the unit is determined based at least in part on an eligibility associated with the unit.

In a second aspect of the invention, a computer-implemented method of operating a plurality of data interfaces in a computerized network comprising a plurality of nodes is disclosed. In one implementation, the method includes: determining a network output based at least in part on individual contributions of the plurality of nodes; based at least in part on a reinforcement indication: determining an eligibility associated with each interface of the plurality of data interfaces; and adjusting a learning parameter associated with the each interface, the adjustment based at least in part on a combination of the output and said eligibility.

In a third aspect of the invention, a computerized robotic system is disclosed. In one implementation, the system includes one or more processors configured to execute computer program modules. Execution of the computer program modules causes the one or more processors to implement a spiking neuron network utilizing a reinforcement learning process that is configured to: determine a performance of the process based at least in part on an output and an input, the output being generated by the process based on the input; and based on at least the performance, provide a reinforcement signal to the process, the signal configured to cause update of at least one learning parameter associated with the process. In one variant, the process output is based on a plurality of outputs by a plurality of nodes of the network, individual ones of the plurality of outputs being generated based on at least a part of the input; and the update is configured based on a comparison of the process output with individual ones of the plurality of outputs.

In a fourth aspect of the invention, a method of operating a neural network having a plurality of neurons and connections is disclosed. In one implementation, the method includes: operating the network using a first subset of the plurality of neurons and connections in a first learning mode; and operating the network using a second subset of the plurality of neurons and connections in a second learning mode, the second subset being larger in number than the first subset, the operation of the network using the second subset in a second operating mode increasing the learning rate of the network over operation of the network using the second subset in the first mode.

In a fifth aspect of the invention, a method of enhancing the learning performance of a neural network having a plurality of neurons is disclosed. In one implementation, the method comprises attributing one or more reinforcement signals to appropriate individual ones of the plurality of neurons using a prescribed learning rule that accounts for at least an eligibility of the individual ones of the neurons for the reinforcement signals.

In a sixth aspect of the invention, a robotic apparatus is disclosed. In one implementation, the apparatus is capable of accelerated learning performance, and includes: a neural network having a plurality of neurons; and logic in signal communication with the neural network, the logic configured to attribute one or more reinforcement signals to appropriate individual ones of the plurality of neurons of the network using a prescribed learning rule, the rule configured to account for at least an eligibility of the individual ones of the neurons for the reinforcement signals.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

FIG. 1 is a block diagram illustrating an adaptive controller comprising a spiking neuron network operable in accordance with a reinforcement learning process, in accordance with one or more implementations.

FIG. 2 is a logical flow diagram illustrating a generalized method of credit assignment in a spiking neuron network, in accordance with one or more implementations.

FIG. 3A is a logical flow diagram illustrating a generalized link function determination for use with e.g., the method of FIG. 2, in accordance with one implementation.

FIG. 3B is a logical flow diagram illustrating correlation-based link function determination for use with e.g., the method of FIG. 2, in accordance with one implementation.

FIG. 4A is a plot representing cumulative error as a function of network population size, in accordance with one or more implementations.

FIG. 4B is a plot representing cumulative error as a function of network population size, in accordance with one or more implementations.

FIG. 5 is a plot illustrating learning results obtained with the methodology of the prior art.

FIG. 6 is a plot illustrating learning results obtained in accordance with one or more implementations of the optimized reinforcement learning methodology of the disclosure.

All Figures disclosed herein are © Copyright 2012 Brain Corporation. All rights reserved.

### DETAILED DESCRIPTION

Implementations of the present disclosure will now be described in detail with reference to the drawings, which are provided as illustrative examples so as to enable those skilled in the art to practice the disclosure. Notably, the figures and examples below are not meant to limit the scope of the present disclosure to a single implementation, but other implementations are possible by way of interchange of or combination with some or all of the described or illustrated elements. Wherever convenient, the same reference numbers will be used throughout the drawings to refer to same or similar parts.

Where certain elements of these implementations can be partially or fully implemented using known components, only those portions of such known components that are necessary for an understanding of the present disclosure will be described, and detailed descriptions of other portions of such known components will be omitted so as not to obscure the disclosure.

In the present specification, an implementation showing a singular component should not be considered limiting; rather, the disclosure is intended to encompass other implementations including a plurality of the same component, and vice-versa, unless explicitly stated otherwise herein.

Further, the present disclosure encompasses present and future known equivalents to the components referred to herein by way of illustration.

As used herein, the terms “computer”, “computing device”, and “computerized device” may include one or more of personal computers (PCs) and/or minicomputers (e.g., desktop, laptop, and/or other PCs), mainframe computers, workstations, servers, personal digital assistants (PDAs), handheld computers, embedded computers, programmable logic devices, personal communicators, tablet computers, portable navigation aids, J2ME equipped devices, cellular telephones, smart phones, personal integrated communication and/or entertainment devices, and/or any other device capable of executing a set of instructions and processing an incoming data signal.

As used herein, the term “computer program” or “software” may include any sequence of human and/or machine cognizable steps which perform a function. Such program may be rendered in a programming language and/or environment including one or more of C/C++, C#, Fortran, COBOL, MATLAB™, PASCAL, Python, assembly language, markup languages (e.g., HTML, SGML, XML, VoXML), object-oriented environments (e.g., Common Object Request Broker Architecture (CORBA)), Java™ (e.g., J2ME, Java Beans), Binary Runtime Environment (e.g., BREW), and/or other programming languages and/or environments.

As used herein, the terms “connection”, “link”, “transmission channel”, “delay line”, “wireless” may include a causal link between any two or more entities (whether physical or logical/virtual), which may enable information exchange between the entities.

As used herein, the term “memory” may include an integrated circuit and/or other storage device adapted for storing digital data. By way of non-limiting example, memory may include one or more of ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, PSRAM, and/or other types of memory.

As used herein, the terms “integrated circuit”, “chip”, and “IC” are meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), application-specific integrated circuits (ASICs).

As used herein, the terms “processor”, “microprocessor” and “digital processor” are meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die, or distributed across multiple components.

As used herein, the term “network interface” refers to any signal, data, or software interface with a component, network or process including, without limitation, those of the FireWire (e.g., FW400, FW900, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11), WiMAX (802.16), PAN (e.g., 802.15), cellular (e.g., 3G, LTE/LTE-A/TD-LTE, GSM, etc.) or IrDA families.

As used herein, the terms “node”, “neuron”, and “neural node” are meant to refer, without limitation, to a network unit (such as, for example, a spiking neuron and a set of synapses configured to provide input signals to the neuron), a having parameters that are subject to adaptation in accordance with a model.

As used herein, the terms “pulse”, “spike”, “burst of spikes”, and “pulse train” are meant generally to refer to, without limitation, any type of a pulsed signal, e.g., a rapid change in some characteristic of a signal, e.g., amplitude, intensity, phase or frequency, from a baseline value to a higher or lower value, followed by a rapid return to the baseline value and may refer to any of a single spike, a burst of spikes, an electronic pulse, a pulse in voltage, a pulse in electrical current, a software representation of a pulse and/or burst of pulses, a software message representing a discrete pulsed event, and any other pulse or pulse type associated with a discrete information transmission system or mechanism.

As used herein, the term “synaptic channel”, “connection”, “link”, “transmission channel”, “delay line”, and “communications channel” include a link between any two or more entities (whether physical (wired or wireless), or logical/virtual) which enables information exchange between the entities, and may be characterized by a one or more variables affecting the information exchange.

### Overview

The present innovation provides, inter alia, apparatus and methods for implementing reinforcement learning in artificial spiking neuron networks.

In one or more implementations, the spiking neural network (SNN) may comprise a large number of neurons, in excess of ten. In order to adequately attribute reinforcement signals to the appropriate individual neurons, all or a portion of the neurons within the network may be operable in accordance with a modified learning rule. The modified learning rule may provide information relating the present activity of the whole (or majority) population of the network to one or more neurons within the network. Such information may enable a local comparison of the local output Sⱼ(t) generated by the individual j-th neuron with the output u(t) of the network. When both behaviors (e.g, {Sⱼ(t), u(t)}) are consistent with one another or otherwise meet specified criteria, the global reward/penalty may be appropriate for the given j-th neuron. When the two outputs {Sⱼ(t), u(t)} are not consistent with one another or do not meet the specified criteria, the respective neuron may not be eligible to receive the reward.

The consistency of the outputs may be determined in one implementation based on the information encoding within the network, as well as the network output. By way of illustration, the output Sⱼ(t) of the j-th neuron may be deemed “consistent” with the network output u₁(t) when (i) the j-neuron is active (i.e., generates output spikes); and (ii) the network output u₁(t) changes such that it minimizes the performance function F(t). In other words, the performance function value F₁, corresponding to the network output comprising the output Sⱼ(t) is smaller, compared to the performance function value F₂, determined for the network output u₂(t) that does not contain the output Sⱼ(t) of the j-th neuron: F₁<F₂.

In some implementations, a neuron providing inconsistent output may receive weaker reinforcement, compared to neurons providing consistent output. In some implementations, the neuron providing inconsistent output may receive negative reinforcement, or may not be reinforced at all.

The optimized reinforcement learning of the disclosure advantageously enables appropriate allocation of the reward signal within populations of neurons (especially larger ones), thereby improving network learning and operation. In some implementations, such improved network operation may be manifested as reduced residual error, and/or an increase in the probability of arriving at an optimal solution in a shorter period of time as compared to the prior art, thus improving learning speed and convergence.

### Adaptive Apparatus

Detailed descriptions of the various implementations of the apparatus and methods of the disclosure are now provided. Although certain aspects of the disclosure can best be understood in the context of an adaptive robotic control system comprising a spiking neural network, the innovation is not so limited, and implementations thereof may also be used for implementing a variety of learning systems, such as for example signal prediction (supervised learning), and data mining.

Implementations of the disclosure may be, for example, deployed in a hardware and/or software implementation of a neuromorphic computer system. A robotic system may include for example a processor embodied in an application specific integrated circuit (ASIC), which can be adapted or configured for use in an embedded application (such as for instance a prosthetic device).

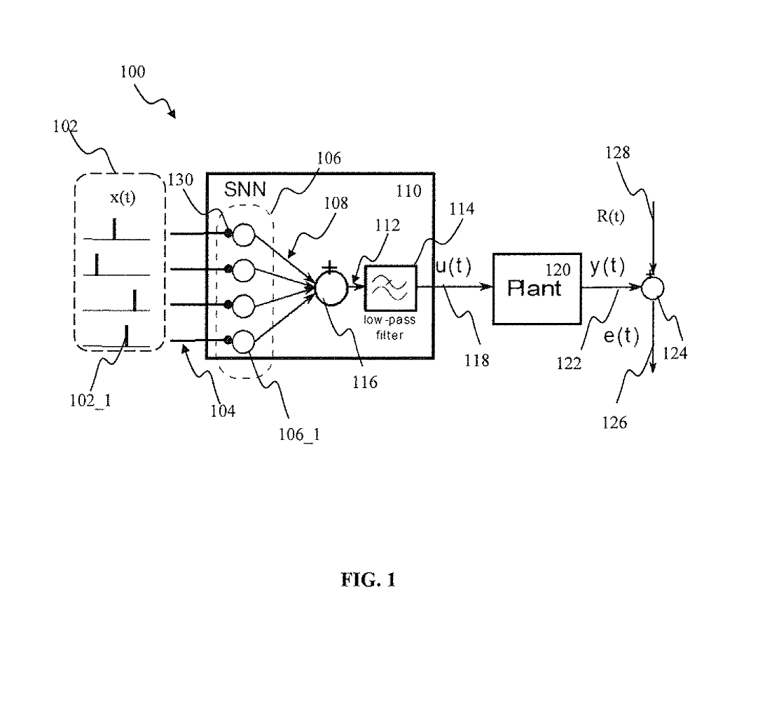

FIG. 1 illustrates one exemplary learning apparatus useful with the various aspects of the disclosure. The apparatus 100 shown in FIG. 1 may comprise adaptive controller block 110 (such as for example a computerized controller for a robotic arm) coupled to a plant (e.g., the robotic arm) 120. The adaptive controller 110 may be configured to receive an input signal x(t) 102, and to produce output u(t) 118 configured to control the plant 120. In some implementations, the apparatus 110 may be configured to receive a teaching signal 128; e.g., a desired plant output y^{d} (t), and the output u(t) may be configured to control the plant to produce a plant output y(t) 122 that is consistent with the desired plant output y^{d}(t). In one or more implementations, the relationship (e.g., consistency) between the actual plant output y(t) 122 and the desired plant output y^{d}(t) may be determined based on an error measure 124. For example, in one exemplary case, the error measure may comprise a distance d:

F(t)=d(y(t),y^{d}(t)), (Eqn. 2)

In some implementations, such as when characterizing a control block utilizing analog output signals, the distance function may be determined using a squared error estimate as follows:

F(t)=(y(t)−y^{d}(t))². (Eqn. 3)

as described in detail in U.S. patent application Ser. No. 13/487,533 entitled “STOCHASTIC SPIKING NETWORK APPARATUS AND METHODS”, filed on Jun. 4, 2012, incorporated herein in its entirety, although it will be readily appreciated by those of ordinary skill given the present disclosure that different error or relationship measures or functions may be used consistent with the disclosure.

In some implementations, the adaptive controller 110 may comprise one or more spiking neuron networks 106 comprising one or more spiking neurons (e.g., the neuron 106_1 in FIG. 1). The network 106 may be configured to implement a learning rule optimized for reinforcement learning by large populations of neurons (e.g., the neurons 106_1 in FIG. 1). The neurons 106_1 of network 106 may receive the input 102 via one or more input interfaces 104. The input 102 may comprise for example one or more input spike trains 102_1, communicated to the one or more neurons 106 via respective interfaces 104.

In one or more implementations, the interface 104 of the apparatus 100 shown in FIG. 1 may comprise input synaptic connections, such as for example associated with an output of a sensory encoder, such as that described in detail in U.S. patent application Ser. No. 13/465,903, entitled “SENSORY INPUT PROCESSING APPARATUS AND METHODS IN A SPIKING NEURAL NETWORK”, filed May 7, 2012, incorporated herein by reference in its entirety. In one such implementation, the learning parameter wⱼᵢ(t) may comprise a connection synaptic weight.

In some implementations, the spiking neurons 106 may be operated in accordance with a neuronal model configured to generate spiking output 108, based on the input 102. In some configurations, the spiking output 108 of the individual neurons may be added using an addition block 116, thereby generating the network output 112.

In some implementations, the network output 112 may be used to generate the output 118 of the controller block 110; the controller output 118 may be generated from e.g., the using a low pass filter block 114. In some implementations, the low pass filter block may for example be described as:

u(t)=∫₀^{∞}u₀(s−t)e^{s/τ}ds (Eqn. 4)

where:

u₀(t) is the network output signal 112;

τ is the filter time-constant; and

s is the integration variable.

In some implementations, the controller output 118 may comprise one or more analog output signals.

In some implementations, the controller apparatus 100 may be trained using the actor-critic methodology described, for example, in U.S. patent application Ser. No. 13/238,932, entitled “ADAPTIVE CRITIC APPARATUS AND METHODS”, filed Sep. 21, 2011, incorporated supra. In one such implementation, the adaptive critic methodology may enable efficient implementation of reinforcement learning due to its fast learning convergence and applicability to a variety of reinforcement learning applications (e.g., in path planning for navigation and/or robotic platform stabilization).

The controller apparatus 100 may also be trained using the focused exploration methodology described, for example, in U.S. patent application Ser. No. 13/489,280, filed Jun. 5, 2012, entitled, “APPARATUS AND METHODS FOR REINFORCEMENT LEARNING IN ARTIFICIAL NEURAL NETWORKS”, incorporated supra. In one such implementation, the training may comprise potentiation of inactive neurons in order to, for example, increase the pool of neurons that may contribute to learning, thereby increasing network learning rate (e.g., via faster convergence).

It will be appreciated by those skilled in the arts that other training methodologies of reinforcement learning may be utilized as well. It is also appreciated that the reinforcement learning of the disclosure may be selectively or dynamically applied, such as for example where a given neural network operating with a first number of neurons (and a given number of inactive neurons) may not require the reinforcement learning rules; however, upon potentiation of inactive neurons as referenced above, the number of active neurons grows beyond a given boundary or threshold, and the reinforcement learning rules are then applied to the larger (active) population.

In some implementations, the neurons 106_1 of the network 106 may be operable in accordance with an optimized reinforcement learning rule. The optimized rule may be configured to modify learning parameters 130 associated with the interfaces 104, such as in the following exemplary relationship:

$$\frac{d {θ}_{ji}}{d t} = η F ( t ) H ( {e}_{ji} , u ) , \qquad ( Eqn . 5 )$$

### Where:

θⱼᵢ(t) is the learning parameter of the connection between the pre-synaptic neuron i and the post-synaptic neuron j;
η is a parameter referred to as the learning rate;
F(t) is a performance function that may be related to the instantaneous and/or the cumulative cost;
eⱼᵢ(t) is eligibility trace, configured to characterize correlation between pre-synaptic and post-synaptic activity; and
H is a link function that may be configured to link the network output signal u(t) with the output Sⱼ(t) of the particular units within a population of units, which is reflected in the eligibility traces eⱼᵢ(t).

In some implementations, the learning parameter θⱼᵢ(t) may comprise a connection efficacy. Efficacy as used in the present context may refer to a magnitude and/or probability of input spike influence on neuronal response (i.e., output spike generation or firing), and may comprise for example a parameter—synaptic weight—by which one or more state variables of post synaptic unit are changed.

In some implementations, the parameter η may be configured as a constant, or as a function of neuron parameters (e.g., voltage) and/or synapse parameters.

In some implementations, the performance function F may be configured based on an instantaneous cost measure, such as for example that described in U.S. patent application Ser. No. 13/487,499, filed Jun. 4, 2012, and entitled “APPARATUS AND METHODS FOR IMPLEMENTING GENERALIZED STOCHASTIC LEARNING RULES”, incorporated herein by reference in its entirety. The performance function may also be configured based on a cumulative or other cost measure.

In one or more implementations, information provided by the link function H may comprise a complete (or a partial) description of relationship between u(t) and eⱼᵢ(t), as illustrated in detail below with respect to Eqn. 13-Eqn. 19.

By way of background, an exemplary eligibility trace (eⱼᵢ(t) in Eqn. 5 above) may comprise for instance a temporary record of the occurrence of an event, such as visiting of a state or the taking of an action, or a receipt of pre-synaptic input. The trace marks the parameters associated with the event (e.g., the synaptic connection, pre- and post-synaptic neuron IDs) as eligible for undergoing learning changes. In one approach, when a reward signal occurs, only eligible states or actions are ‘assigned credit’, or conversely ‘blamed’ for the error.

In one or more implementations, the eligibility trace of a given connection may be incremented every time a pre-synaptic and/or a post-synaptic neuron generates a response (spike). In some implementations, the eligibility trace may be configured to decay with time. It may also be configured based on a relationship between the input (provided by a pre-synaptic neuron i to a post-synaptic neuron j) and the output, generated by the neuron j), and may be expressed as follows:

eᵢⱼ(t)=∫₀^{∞}γ₂(t−t′)gᵢ(t′)Sⱼ(t′)dt′, (Eqn. 6)

where:

gᵢ(t)=∫₀^{∞}γ₁(t−t′)Sᵢ(t′)dt′. (Eqn. 7)
gᵢ(t) is the trace of the pre-synaptic activity Sᵢ(t);
Sⱼ(t) is the post-synaptic activity;
γ1 and γ2 are the low-pass filter kernels; and

In some implementations, the kernels γ1 and/or γ2 may comprise exponential low-pass filter (LPF) kernels, described for example by Eqn. 4

In some implementations, the neuron activity may be described using a spike train, such as for example the following:

S(t)=Σ_{ƒ}δ(t−t^{ƒ}), (Eqn. 8)

where ƒ=1, 2, . . . is the spike designator and δ(·) is the Dirac function with δ(t)=0 for t≠0 and

∫_{-∞}^{∞}δ(t)dt=1 (Eqn. 9)

By way of illustration, the implementation described by Eqn. 5 presented supra may enable comparison of the individual neuron output Sⱼ(t) with the network output u(t). In some cases, such as for example when each neuron may be implemented as a separate hardware/software block, the comparison may be effectuated locally, by each individual j-th neuron (block). The comparison may also or alternatively be effectuated globally, by the network with access to the output for each individual neuron. In some implementations, output Sⱼ(t) of the j-th neuron may be expressed as a causal dependence ℑ{·} on the respective eligibility traces eⱼᵢ(t), such as according to the following relationship:

Sⱼ(t)∝ [symbol] {PSP[eⱼᵢ(t−Δt)]}, (Eqn. 10)

where PSP[·] denotes post-synaptic potential (e.g., neuron membrane voltage), and Δt is the update interval.

When the neuron output Sⱼ(t) is consistent with (or otherwise is compliant with one or more prescribed acceptance criteria), the network output u(t), global reward/penalty may be appropriate for the given j-th neuron. Conversely, the neuron that does not produce output consistent with the network may not be eligible for the reward/penalty that may be associated with the network output. Accordingly, such ‘inconsistent’ and/or non-compliant neurons may not be rewarded (e.g., by not receiving positive reinforcement) in some implementations. The ‘inconsistent’ neurons may alternatively receive an opposite reinforcement (e.g., negative reinforcement) as compared to the neurons providing consistent or compliant output.

### Network Output to Neuron Activity Link

In some implementations, the link relationship H between the network output u(t) and the neuron output Sⱼ(t) may be configured using the neuron eligibility traces eⱼᵢ(t), as described in greater detail below. For purposes of illustration, several exemplary implementations of the link function H[eⱼᵢ(t),u(t)] of Eqn. 5 above are described in detail. It will be appreciated by those skilled in the arts that such implementations are merely exemplary, and various other implementations of H[eⱼᵢ(t),u(t)]) may be used consistent with the present disclosure.

### Additive Output

In one or more implementations, the link function H[eⱼᵢ(t),u(t)]) may be configured based on the network output u(t) comprising a sum of the activity of one or more neurons as follows:

u(t)=Σⱼ₌₁^{N}Sⱼ(t) (Eqn. 11)

In one or more implementations, the network output u(t) may be determined as a weighted sum of individual neuron outputs (e.g., neurons 106 in FIG. 1).

In some implementations, the network output u(t) may be based on one or more sub-populations of neurons. This/these subpopulation(s) may be selected based on for example neuron activity (or lack of activity), coordinates within the network layout, or unit type (e.g., S-cones of a retinal layer). In some implementations, the sub-population selection may be effectuated using markers, such as e.g., the tags of the high level neuromorphic description (HLND) framework described in detail in co-pending and co-owned U.S. patent application Ser. No. 13/985,933 entitled “TAG-BASED APPARATUS AND METHODS FOR NEURAL NETWORKS” filed on Jan. 27, 2012, incorporated supra.

In some implementations, network output may comprise a sum of low-pass filtered neuron activity, such as that of Eqn. 12 below:

u(t)=Σⱼ₌₁^{N}Zⱼ(t);Zⱼ(t)=γ(t)*Sⱼ(t) (Eqn. 12)

where γ is the filter kernel, and the asterisk (*) denotes the convolution operation.

### Gradient Link

In some implementations, the link function H may be configured based on a rate of change of the network output, such as according to Eqn. 13 below:

$$H ( {e}_{ji} , u ) = {e}_{ji} ( t ) \frac{d u}{d t} , \qquad ( Eqn . 13 )$$

The description of Eqn. 13 may also be modified to enable a non-trivial link based on a particular condition applied to the output rate of change. For example, the applied condition may be configured based on a positive sign of the network output rate of change as follows:

$$\{ \begin{matrix}H ( {e}_{ji} , u ) = {e}_{ji} ( t ) \frac{d u}{d t} , & if {e}_{ji} ( t ) \frac{d u}{d t} > 0 \\ H ( {e}_{ji} , u ) = 0 , & elsewhere ,\end{matrix} \qquad ( Eqn . 14 )$$

In other words, the implementation of Eqn. 14 may be used to link the neuron activity and the network output when network output increases from its initial value (e.g., zero), such as for example when controlling a motor spin-up. Once the network output stabilizes u(t)˜U (e.g., the motor has reached its nominal RPM), the link value of Eqn. 14 becomes zero.

In other implementations, the applied condition may comprise a decreasing output, an output within a specific range, an output above a certain threshold, etc. Various combinations and permutations of the foregoing will also be recognized by those of ordinary skill given the present disclosure.

Various implementations of Eqn. 11-Eqn. 14 set forth supra may be used to, inter alia, link increasing (or decreasing) network output with an increasing (or decreasing) number of active (or inactive) neurons. By way of illustration, when at a certain time both du/dt and eⱼᵢ(t) are positive, it may be more likely that the traces eⱼᵢ(t) contribute to the increase of u(t) over time. Accordingly, whatever reinforcement may be associated with the observed increase of u(t), the reinforcement may be appropriate for the neuron j, with which the eligibility trace eⱼᵢ(t) is associated.

Conversely, in some implementations, when eⱼᵢ(t) is positive, but du/dt is negative, it may be likely that the traces eⱼᵢ(t) do not contribute to the decrease of du/dt. Accordingly, the reinforcement that may be associated with the decrease of du/dt may not be applied to the unit j, in accordance with the implementation of Eqn. 14. In some implementations (not shown) the reinforcement of an opposite sign may be applied.

Implementations of Eqn. 13-14 do not apply reinforcement to ‘inactive’ neurons whose eligibility traces are zero: eⱼᵢ(t)=0, corresponding to absence of pre-synaptic and post-synaptic activity. In some implementations, such as for example that described in U.S. patent application Ser. No. 13/489,280, filed Jun. 5, 2012, entitled, “APPARATUS AND METHODS FOR REINFORCEMENT LEARNING IN ARTIFICIAL NEURAL NETWORKS, incorporated supra, the inactive neurons may be potentiated in order to broaden the pool of network resources that may cooperate at seeking most optimal solution to the learning task. It will be appreciated by those skilled in the arts that implementations of Eqn. 11-Eqn. 14 are exemplary, and many other implementations of neuron credit assignment may be used.

The description of Eqn. 13-Eqn. 14 may also be reformulated as follows:

$$H ( {e}_{ji} , u ) = {e}_{ji} ( t ) \frac{d u}{d t} \frac{\partial u}{\partial {e}_{ji}} , \qquad ( Eqn . 15 )$$

The realization of Eqn. 15 may be used with a network learning process configured so that network output u(t) may be expressed as a differentiable function of the traces eⱼᵢ(t), in one or more implementations. In some implementations, the of Eqn. 15 may be used when the process comprises known partial derivative of u(t) with respect to eⱼᵢ(t). Various approximation methodologies may also be used in order to obtain partial derivative of Eqn. 15. By way of example, the network output may be approximated by an arbitrary differentiable function of eⱼᵢ(t) such that partial derivative of u(t) with respect to eⱼᵢ(t) has a known solution and/or the solution may be determined via an approximation.

### Direction-Based Links

In some implementations, the link relationship H between the network output u(t) and the neuron output Sⱼ(t) (expressed using the respective eligibility traces to eⱼᵢ(t)) may be configured based on the product of signs (i.e., direction of the change) of (i) the rate of change of the network output; and (ii) the gradient of the network output with respect to the eligibility trace. In one or more implementations, this may be expresses as follows:

$$H ( {e}_{ji} , u ) = {e}_{ji} ( t ) sign ( \frac{d u}{d t} ) sign ( \frac{\partial u}{\partial {e}_{ji}} ) , \qquad ( Eqn . 16 )$$

### Sigmoid-Based Link Relationship

In some implementations, the link relationship H between the network output u(t) and the neuron output Sⱼ(t) may be configured based on the product of sigmoid functions of (i) the rate of change of the network output; and (ii) the gradient of the network output with respect to the eligibility trace. In one or more implementations, this may be expresses as follows:

$$H ( {e}_{ji} , u ) = {e}_{ji} ( t ) P ( \frac{d u}{d t} ) P ( \frac{\partial u}{\partial {e}_{ji}} ) , \qquad ( Eqn . 17 )$$

where the P(·) denotes a sigmoid distribution. Sigmoid dependences may be utilized in describing processes (e.g., learning) characterized by varying growth rate as a function of time. Furthermore, sigmoid functions may be applied in order to introduce soft-limits on the values of variables inside the function. This behavior is advantageous, as it may aid in preventing radical changes in value of H due to noise and/or transient state changes, etc.

In one or more implementations, the generalized form of the sigmoid distribution of Eqn. 17 may be expressed as:

$$P ( t ) = A + \frac{K - A}{{( 1 + Q {e}^{- B ( t - M )} )}^{1 / μ}} \qquad ( Eqn . 18 )$$

where:
t denotes the argument

$$( e . g . , \frac{d u}{d t} , \frac{\partial u}{\partial {e}_{ji}} ) ;$$

A, K denote the lower and the upper asymptote, respectively;
B denotes the growth rate;
μ>0 parameter configured to control near which asymptote (e.g., A or K) maximum growth rate occurs;
Q may be dependent on the value at zero (P(0)); and
M is the argument value for the maximum growth when Q=μ.

### Correlation-Based Link

In some implementations, the relationship between the network output u and the activity of the individual neurons can be evaluated using for example a correlation function, as follows:

$$H ( {e}_{ji} , u ) = corr ( {e}_{ji} ( t ) , \frac{d u}{d t} ) \frac{\partial u}{\partial {e}_{ji}} . \qquad ( Eqn . 19 )$$

The formulation of Eqn. 19 comprises an extension of Eqn. 15, and may be employed without relying on a multiplication of eⱼᵢ(t) and /dt in order to provide a measure of the consistency of e(t) and du/dt.

### Performance-Based Link

In one or more implementations, the link function H of Eqn. 5 may be configured by relating single neuron activity eⱼᵢ(t) with the performance function F of the network learning process as follows:

$$\frac{d {θ}_{ji}}{d t} = η H ( {e}_{ji} , F ) , \qquad ( Eqn . 20 )$$

In some implementations, the performance function in Eqn. 20 may be implemented using Eqn. 2-Eqn. 3. In one or more implementations, the performance function F may be configured using approaches described, for example, in U.S. patent application Ser. No. 13/487,533 entitled “STOCHASTIC SPIKING NETWORK APPARATUS AND METHODS”, filed on Jun. 4, 2012, incorporated supra.

Compared to the prior art, the optimized learning rule of Eqn. 20 advantageously couples learning (e.g., weight adjustment characterized by term

$$\frac{d {θ}_{ij} ( t )}{d t} )$$

to both the (i) reinforcement signal describing the overall performance of the plant 120; and (ii) control activity of the output u(t) of the controller block 110.

As shown in FIG. 1, the approximation error e(t) 126 may be influenced by the control output signal u(t). While in a small network (i.e., few neurons), the change in the control output 118 may readily be attributed to the activity of particular neurons, as the number of neurons grows, this attribution may become less accurate. In some prior art techniques, averaging effects associated with larger populations of neurons may cause biasing, where the population activity (e.g., the control output) may be represented primarily by activity of a subset (e.g., the majority) of neurons, rather than of all neurons. Accordingly, if no consideration is given to the averaging, a reward signal that is based on the averaged network output may incorrectly promote the inappropriate behavior of a portion of neurons that did not contribute to the rewarded change of u(t).

### Exemplary Methods

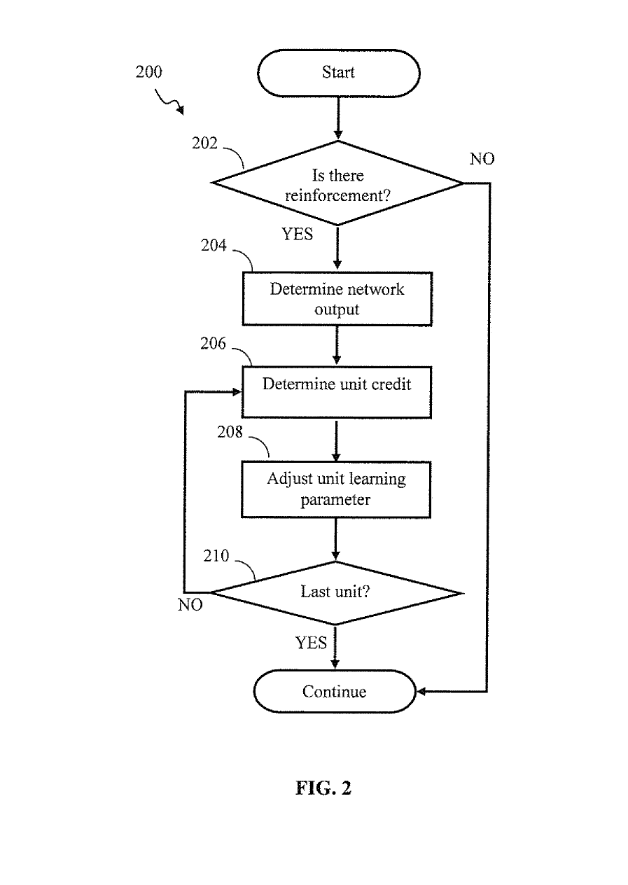

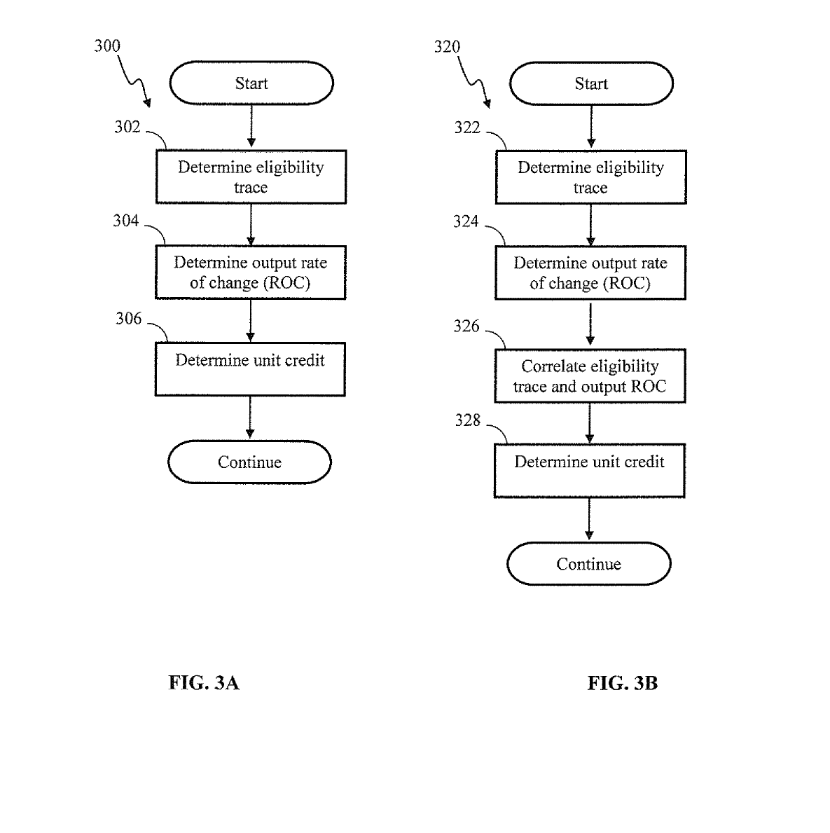

FIGS. 2-3B illustrate exemplary methodology of optimized reinforcement learning in accordance with one or more implementations. The methodology described with respect to FIGS. 2-3 may be utilized by a computerized neuromorphic apparatus, such as for example the apparatus described in U.S. patent application Ser. No. 13/487,533 entitled “STOCHASTIC SPIKING NETWORK APPARATUS AND METHODS” filed on Jun. 4, 2012, incorporated supra.

FIG. 2 illustrates one exemplary method of optimized network adaptation during reinforcement learning in accordance with one or more implementations.

At step 202 of method 200, a determination may be performed whether reinforcement indication is present in order to aid network operation (e.g., synaptic adaptation). In some implementations of neural network controllers, the reinforcement indication may be capable of causing modification of controller parameters in order to improve the control rules so as to minimize, for example, performance measure associated with the controller performance. In some implementations, the reinforcement signal R(t) comprises two or more states:
(i) a base state (e.g., zero reinforcement, signified, for example, by absence of signal activity on the respective input channel, zero value of a register or a variable, etc.). The zero reinforcement state may correspond, for example, to periods when network activity has not arrived at an outcome, e.g., the exemplary robotic arm is moving towards the desired target; or when the performance of the system does not change or is precisely as predicted by the internal performance predictor (as for example described in co-owned U.S. patent application Ser. No. 13/238,932 filed Sep. 21, 2011, and entitled “ADAPTIVE CRITIC APPARATUS AND METHODS” incorporated supra); and
(ii) a first reinforcement state (i.e., positive reinforcement, signified for example by a positive amplitude pulse of voltage or current, binary flag value of one, a variable value of one, etc.). Positive reinforcement is provided when the network operates in accordance with the desired signal (e.g., the robotic arm has reached the desired target), or when the network performance is better than predicted by the performance predictor, as described for example in co-owned U.S. patent application Ser. No. 13/238,932, referenced supra.

In one or more implementations, the reinforcement signal may further comprise a third reinforcement state (i.e., negative reinforcement, signified, for example, by a negative amplitude pulse of voltage or current, a variable value of less than one (e.g., −1, 0.5, etc.). Negative reinforcement is provided for example when the network does not operate in accordance with the desired signal, e.g., the robotic arm has reached wrong target, and/or when the network performance is worse than predicted or required.

It will be appreciated by those skilled in the arts that other reinforcement implementations may be used with the method 200 of FIG. 2, such as for example use of two different input channels to provide for positive and negative reinforcement indicators, a bi-state or tri-state logic, integer, or floating point register, etc. Moreover, reinforcement (including negative reinforcement) may be implemented in a graduated and/or modulated fashion; e.g., increasing levels of negative or positive reinforcement based on the level of “inconsistency”, increasing or decreasing frequency of application of the reinforcement, or so forth.

If the reinforcement indication is present, the method may proceed to step 204 where network output may be determined. In some implementations, the network output may comprise a value that may have been obtained prior to the reinforcement indication and stored, for example, in a memory location of the neuromorphic apparatus. In one or more implementations, the network output may be determined in response to the reinforcement indication using, for example Eqn. 11.

At step 206 of the method 200, a “unit credit” may be determined for each unit of the network being adapted. In some implementations, the unit may comprise a synaptic connection, e.g., the connection 104 in FIG. 1, or groups or aggregations of connections. In one or more implementations, the unit credit may be determined based on the input (e.g., the input 102 in FIG. 1) from a pre-synaptic neuron; the unit credit may also be determined based on the output (e.g., the output 108 in FIG. 1) of post-synaptic neuron. In some implementations, the unit may comprise the neuron (e.g., the neuron 106 in FIG. 1). In some implementations, the neuron may comprise logic implementing synaptic connection functionality, such as comprising elements 104, 1130, 106 in FIG. 1). The unit credit may be determined for example using the optimized adaptation methodology described above with respect to Eqn. 13-Eqn. 20.

At step 208, learning parameter associated with the unit may be adapted. In some implementations, the learning parameter may comprise synaptic weight. Other learning parameters may be utilized as well, such as, for example, synaptic delay, and probability of transmission. In some implementations, the unit adaptation may comprise synaptic plasticity effectuated using the methodology of Eqn. 5 and/or Eqn. 20.

At step 210, if there are additional units to be adapted, the method may return to step 206.

In certain implementations, the synaptic plasticity may be effectuated using conditional plasticity adaptation mechanism described, for example, in co-owned and co-pending U.S. patent application Ser. No. 13/541,531, entitled “SPIKING NEURON NETWORK APPARATUS AND METHODS”, filed Jul. 3, 2012, incorporated herein by reference in its entirety.

The synaptic plasticity may also be effectuated in other variants using a heterosynaptic plasticity adaptation mechanism, such as for example one configured based on neighbor activity trace, as described for example in co-owned and co-pending U.S. patent application Ser. No. 13/488,106, entitled “SPIKING NEURON NETWORK APPARATUS AND METHODS”, filed Jun. 4, 2012, incorporated herein by reference in its entirety.

FIGS. 3A-3B illustrate exemplary method of unit credit determination for use with the optimized network adaptation methodology such as, for example, described with respect to FIG. 2 above, in accordance with one or more implementations.

At step 302 of method 300 of FIG. 3A, eligibility trace may be determined. In some implementations, the eligibility trace may be configured based on a relationship between the input (provided by a pre-synaptic neuron i to a post-synaptic neuron j) and the output, generated by the neuron j), in accordance with Eqn. 6.

At step 304 of method 300, a rate of change (ROC) of the network output may be determined.

At step 306 of method 300, a unit credit may be determined. In one or more implementations, the unit credit may comprise an amount of reward/punishment due to the unit based on (i) network output; and (ii) unit output associated with the reinforcement received by the network (e.g., the reinforcement indication described above with respect to FIG. 2).

The unit credit may be determined using any applicable methodology, such as, for example, described above with respect to Eqn. 13-Eqn. 15, Eqn, 16, and Eqn. 19, or yet other approaches which will be recognized by those of ordinary skill given the present disclosure.

The exemplary method 320 of FIG. 3B illustrates correlation based unit credit assignment in accordance with one or more implementations. At step 322 of method 320, an eligibility trace may be determined. In some implementations, the eligibility trace may be configured based on a relationship between the input (provided by a pre-synaptic neuron i to a post-synaptic neuron j) and the output, generated by the neuron j), in accordance with Eqn. 6.

At step 324 of method 320, a rate of change (ROC) of the network output may be determined.

At step 326 of method 320, a correlation between the network output ROC and unit output (e.g., expressed via the eligibility trace) may be determined.

At step 328 of method 320, unit credit may be determined. In some implementations, the unit credit may be determined using any applicable methodology, such as, for example, described above with respect to Eqn. 19.

### Performance Results

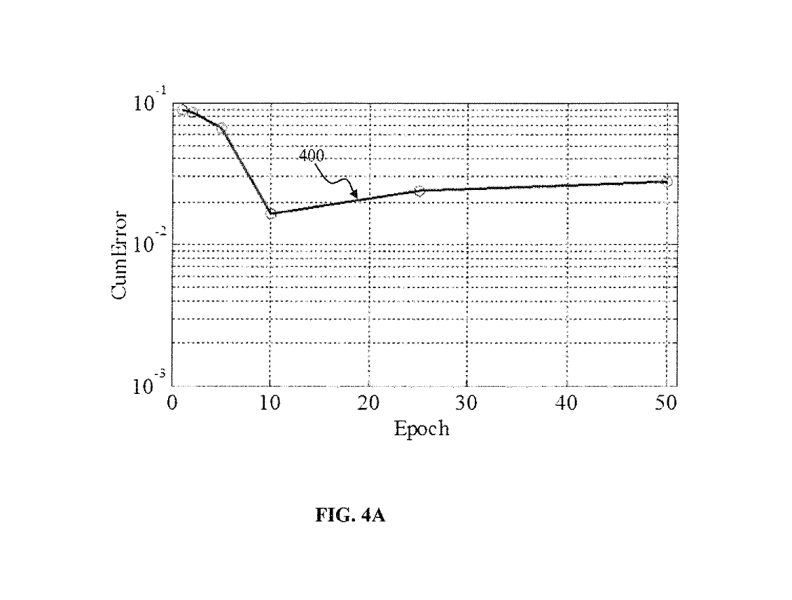

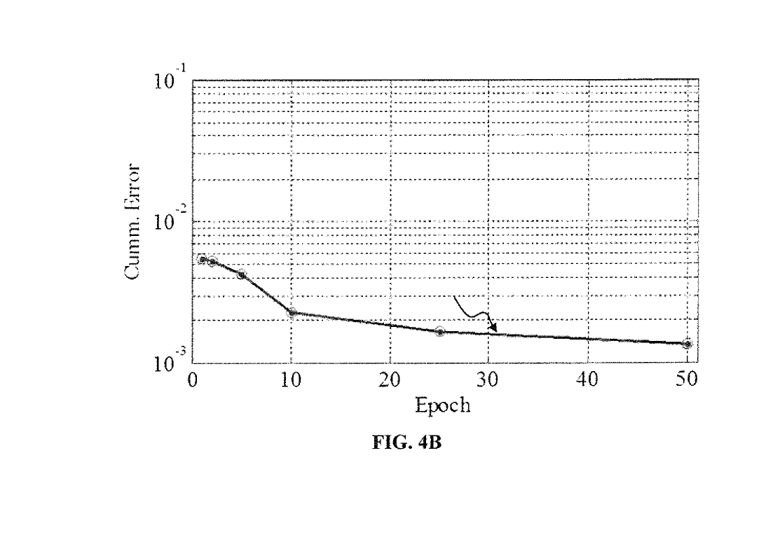

FIGS. 4A through 6 present exemplary performance results obtained during simulation and testing performed by the Assignee hereof of exemplary computerized spiking network apparatus configured to implement the optimized learning framework described above with respect to FIGS. 1-3. The exemplary apparatus, in one implementation, may comprise a motor controller (e.g., the controller 110 of FIG. 1) comprising an spiking neural network (SNN). In some implementations, the SNN may be trained to transform an input signal x(t) (e.g., the input 102 in FIG. 1) into a motor command u(t) (e.g., the output 118 in FIG. 1) that minimizes the error e(t) (e.g., the error 126 in FIG. 1) of the learning process. In one or more implementations, such as described with respect to the data shown in FIGS. 4-6, the signal u(t) may be determined using a low-pass filtered sum (e.g., Eqn. 11-Eqn. 12) of spike trains generated by the individual neurons in the network. The plant (e.g., the plant 120 of FIG. 1) may be modeled, in the implementation described with respect to FIG. 4A-FIG. 6, as a single-input single-output, first-order inertial object. In one or more implementations, the SNN may utilize the actor-critic learning methodology, such as described in U.S. patent application Ser. No. 13/238,932 filed Sep. 21, 2011, and entitled “ADAPTIVE CRITIC APPARATUS AND METHODS” and U.S. patent application Ser. No. 13/489,280, filed Tune 5, 2012, entitled, “APPARATUS AND METHODS FOR REINFORCEMENT LEARNING IN ARTIFICIAL NEURAL NETWORKS”. However, as will be appreciated by those skilled in the arts, the optimized adaptation methodology may qualitatively also be applied to other reinforcement learning methods.

FIGS. 4A-4B illustrate network cumulative error as a function of the network population size. Data shown in FIGS. 4A-4B were obtained with the network population size increasing from 1 to 50 neurons. Each network configuration was trained for 600 trials (epochs). The curve 400 in FIG. 4A presents cumulative error obtained using the prior-art learning rule of the general given by Eqn. 1, for the purposes of comparison. Line 410 in FIG. 4B depicts the results obtained using the unit credit assignment methodology (e.g., the link function H of Eqn. 5 and Eqn. 13), in accordance with one or more implementations.

Comparison of the data shown by the curve 410 with the data of the prior art of the curve 400 demonstrates that the optimized credit assignment methodology of the present disclosure is characterized by better learning performance. Specifically, the optimized learning methodology of the disclosure advantageously results in a (i) lower cumulative error; and (ii) continuing convergence (characterized by the continuing decrease of the error) as the number of neurons in the network increases. It is noteworthy that the prior art methodology achieves it optimum performance when the network is comprised of 10 neurons. Furthermore, the performance of the prior art learning process degrades as the size of the network exceeds 10 neurons.

Contrast to the result of the prior art (the curve 400 in FIG. 4A), the optimized learning methodology of the disclosure advantageously enables the network to benefit from a collective behavior of a greater number of neurons. As shown by the residual error of the curve 410 in FIG. 4B, the controller performance increases (as the error decreases) monotonically with the increase of the number of neurons in the network. The Assignee's analysis of experimental results reveals that the increased network size can result in better system performance anti/or in faster learning. Such improvements are effectuated by, inter alia, a more accurate adjustment of individual neurons due to more accurate credit assignment mechanism described herein. Stated differently, the learning techniques described herein enable more optimal or efficient use of a greater number of neurons, such greater number providing inter alia better performance and faster learning.

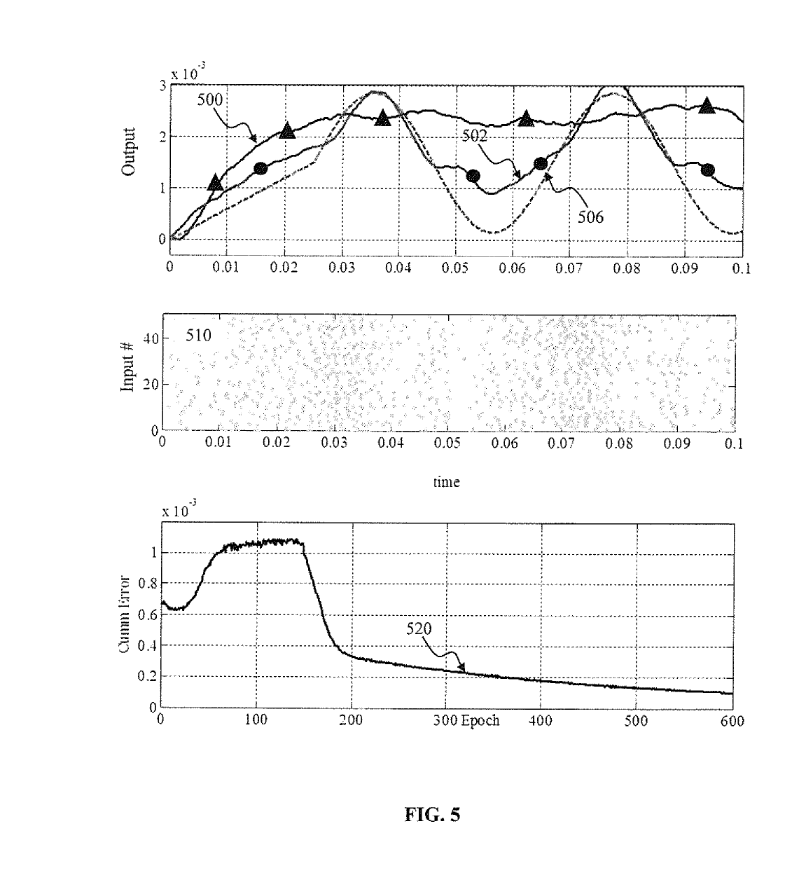

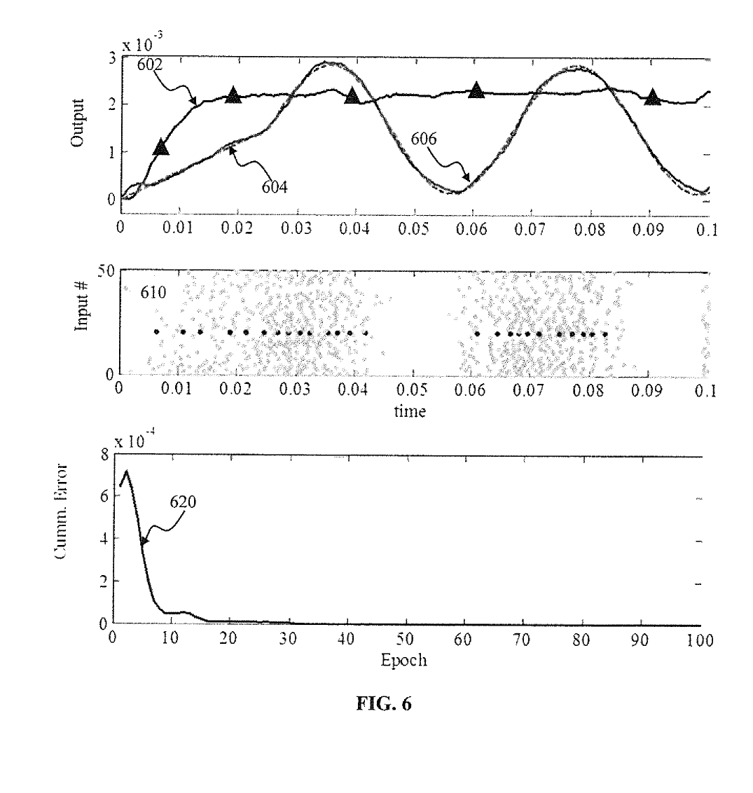

FIG. 6 illustrate exemplary network learning results obtained using the optimized learning methodology described with respect to FIG. 4B for an SSN comprising 50 neurons. FIG. 5 present data obtained using the methodology of the prior art, shown for comparison.

Curve 604 (depicted by broken line in FIG. 6) presents target (desired) output, and the curve 606 in FIG. 6 presents the actual output of the controller, obtained using the unit credit assignment methodology (e.g., the link function H of Eqn. 5 and Eqn. 13), in accordance with one or more implementations. The panel 610 illustrates network input (e.g., the input 102 in FIG. 1). The curve 620 presents residual error as a function of the number of trials (epoch #).

Curve 504 (depicted by broken line in FIG. 5) presents target (desired) output, and the curve 506 in FIG. 5 presents the actual output of the controller, obtained using global reinforcement learning according to the prior art. The panel 510 illustrates network input (e.g., the input 102 in FIG. 1). The curve 520 presents residual error as a function of the number of trials (epoch #).

As seen from the data in FIG. 6, the actual output of the network operable win accordance with the optimized learning methodology of the disclosure, closely follows the desired output (the curves 604, 606) after 100 epochs. Furthermore, residual error rapidly decreases to below 0.2×10⁻⁴ after about 15 trials (the curve 620 in FIG. 6).

On the contrary, the network output of the prior art poorly reproduces desired behavior (the curves 504, 506 in FIG. 5) even after 600 trials. Furthermore, while the residual error 520 decreases with the epoch #, the learning is slower, compared to the data shown by the curve 620 and the error magnitude remains larger (0.1×10⁻³).

Comparison of both methods shows again a superiority of the optimized rule of the disclosure over the traditional approach, in terms of a better approximation precision as well as of faster and more reliable learning.

### Exemplary Uses and Applications of Certain Aspects of the Disclosure

The learning approach described herein may be generally characterized in one respect as solving optimization problems through reinforcement learning. In some implementations, training of neural network through the enhanced learning rules as described herein may be used to control an apparatus (e.g., a robotic device) in order to achieve a predefined goal, such as for example to find a shortest pathway in a maze, find a sequence that maximizes probability of a robotic device to collect all items (trash, mail, etc.) in a given environment (building) and bring it all to the waste/mail bin, while minimizing the time required to accomplish the task. This is predicated on the assumption or condition that there is an evaluation function that quantifies control attempts made by the network in terms of the cost function. Reinforcement learning methods such as for example those described in detail in U.S. patent application Ser. No. 13/238,932 filed Sep. 21, 2011, and entitled “ADAPTIVE CRITIC APPARATUS AND METHODS”, incorporated supra, can be used to minimize the cost and hence to solve the control task, although it will be appreciated that other methods may be used consistent with the present innovation as well.

Faster and/or more precise learning, obtained using the methodology described herein, may advantageously reduce operational costs associated with operating learning networks due to, at least partly, a shorter amount of time that may be required to arrive at a stable solution. Moreover, control of faster processes may be enabled, and/or learning precision performance and reliability improved.

In one or more implementations, reinforcement learning is typically used in applications such as control problems, games and other sequential decision making tasks, although such learning is in no way limited to the foregoing.

The proposed rules may also be useful when minimizing errors between the desired state of a certain system and the actual system state, e.g.: train a robotic arm to follow a desired trajectory, as widely used in e.g., automotive assembly by robots used for painting or welding; while in some other implementations it may be applied to train an autonomous vehicle/robot to follow a given path, for example in a transportation system used in factories, cities, etc. Advantageously, the present innovation can also be used to simplify and improve control tasks for a wide assortment of control applications including without limitation HVAC, and other electromechanical devices requiring accurate stabilization, set-point control, trajectory tracking functionality or other types of control. Examples of such robotic devices may include medical devices (e.g. for surgical robots, rovers (e.g., for extraterrestrial exploration), unmanned air vehicles, underwater vehicles, smart appliances (e.g. ROOMBA®), robotic toys, etc.). The present innovation can advantageously be used also in all other applications of artificial neural networks, including: machine vision, pattern detection and pattern recognition, object classification, signal filtering, data segmentation, data compression, data mining, optimization and scheduling, or complex mapping.

In some implementations, the learning framework described herein may be implemented as a software library configured to be executed by an intelligent control apparatus running various control applications. The learning apparatus may comprise for example a specialized hardware module (e.g., an embedded processor or controller). In another implementation, the learning apparatus may be implemented in a specialized or general purpose integrated circuit, such as, for example ASIC, FPGA, or PLD). Myriad other implementations exist that will be recognized by those of ordinary skill given the present disclosure.

It will be recognized that while certain aspects of the innovation are described in terms of a specific sequence of steps of a method, these descriptions are only illustrative of the broader methods of the innovation, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the innovation disclosed and claimed herein.

While the above detailed description has shown, described, and pointed out novel features of the innovation as applied to various implementations, it will be understood that various omissions, substitutions, and changes in the form and details of the device or process illustrated may be made by those skilled in the art without departing from the innovation. The foregoing description is of the best mode presently contemplated of carrying out the innovation. This description is in no way meant to be limiting, but rather should be taken as illustrative of the general principles of the innovation. The scope of the innovation should be determined with reference to the claims.

What is claimed:

1. A method of credit assignment for an artificial spiking network comprising a plurality of units, the method comprising:
operating said network in accordance with reinforcement learning process capable of generating a network output;
determining a credit based on relating said network output to a contribution of a unit of said plurality of units; and
adjusting a learning parameter associated with said unit based at least in part on said credit;
wherein said contribution of said unit is determined based at least in part on an eligibility associated with said unit.

2. The method of claim 1, wherein:
said operating said network in accordance with said reinforcement learning process is based at least in part on at least one of: a unit input; a unit output; and/or a unit state; and
said credit is determined for individual ones of said plurality of units based at least in part on any of: said unit input; (ii) said unit output; and (iii) said unit state.

3. The method of claim 1, wherein:
said learning parameter comprises a synaptic weight; and
said adjusting is configured to increase said weight based on a positive correlation between said network output and said contribution.

4. A computer-implemented method of operating a plurality of data interfaces in a computerized network comprising a plurality of nodes, the method comprising:
determining a network output based at least in part on individual contributions of said plurality of nodes;
based at least in part on a reinforcement indication:
determining an eligibility associated with individual ones of said plurality of data interfaces; and
adjusting a learning parameter associated with said individual ones of said plurality of data interfaces, said adjustment based at least in part on a combination of said output and said eligibility.

5. The method of claim 4, wherein:
said network is operable in accordance with a reinforcement learning process characterized by said reinforcement indication, said learning parameter, and a process performance;
said output is generated based at least in part on an input provided to said network;
said process performance is configured based at least in part on a quantity capable of being determined based on said input and said output; and
said adjusting said learning parameter causes generation of another network output, the another output characterized by a reduced value of said quantity for said input.

6. The method of claim 5, wherein said adjusting is configured to apply the reinforcement indication to the said learning parameter based on the unit output that is consistent with the network output.

7. The method of claim 5, wherein:
said reinforcement indication is configured based at least in part on said process performance; and
said adjusting comprises improving said process performance.

8. The method of claim 4, wherein said eligibility is configured based at least in part on a temporary record of one or more data events associated with at least one interface of said plurality of data interfaces, said temporary record being characterized by a time interval prior to said reinforcement indication.

9. The method of claim 8, wherein:
said at least one interface comprises a connection between a pre-synaptic node and a post-synaptic node of said plurality of nodes, said pre-synaptic node and a post-synaptic nodes being operable in accordance with a reinforcement learning process capable of causing generation of a node response; and
said one or more data events comprise one or more responses generated by said pre-synaptic node and/or said post-synaptic node.

10. The method of claim 9, wherein:
said eligibility comprises a trace configured to decrease exponentially with time during at least said interval;
one or more of said individual contributions of said plurality of nodes comprise one or more of said responses by said post-synaptic neuron;
said output comprises a weighted average of said individual contributions; and
said combination corresponding to said connection is determined based on a product of (i) said eligibility trace associated with said connection; and (ii) a rate of change of said network output.

11. The method of claim 10, wherein said combination is determined based on a product of (i) said eligibility trace associated with said connection; (ii) a rate of change of said network output; and (iii) a partial derivative of said network output determined with respect to said eligibility trace.

12. The method of claim 10, wherein said combination is set to zero if said rate of change is negative.

13. The method of claim 10, wherein said interval is characterized by a decrease of said trace by a factor of about exp(1) within a duration of said interval.

14. The method of claim 4, wherein: said combination corresponding to said each interface is determined based on a product of (i) said eligibility trace of said each interface; and (ii) a sign of a rate of change of said network output.

15. The method of claim 4, wherein:
said each data interface comprises a synaptic connection;
said learning parameter comprises a weight associated with said connection; and
said adjustment is configured to increase said weight based on a positive correlation of a rate of change of said network output with said eligibility.

16. The method of claim 4, wherein:
said each data interface comprises a synaptic connection;
said learning parameter comprises a weight associated with said connection; and
said adjustment is configured to decrease said weight based on any of (i) a negative correlation of a rate of change of said network output with said eligibility; and (ii) a sign of a rate of change of said network output being opposite to sign of a derivative of said network output with respect to said eligibility.

17. The method of claim 4, wherein said combination comprises a sigmoidal function of a rate of change of said network output.

18. The method of claim 4, wherein:
said each data interface comprises a synaptic connection;
said learning parameter comprises efficacy associated with said connection; and
said adjustment is configured to increase said efficacy when a sign of a rate of change of said network output matches a sign of a derivative of said network output with respect to said eligibility.

19. The method of claim 4, wherein:
said efficacy comprises by a synaptic weight; and
increasing said weight is characterized by a time-dependent function having at least a time window associated therewith.

20. The method of claim 19, wherein:
said individual ones of said plurality of data interfaces are capable of providing an input signal to a node of said plurality of nodes, said input characterized by input time;
said reinforcement signal is characterized by reinforcement time;
said time window is selected based at least in part on said input time and said reinforcement time; and
integration of said time-dependent function over said window is capable of generating a positive value.

21. The method of claim 19, wherein:
said individual ones of said plurality of data interfaces are capable of providing an input signal to a node of said plurality of nodes, said input characterized by input time;
said reinforcement signal is characterized by reinforcement time;
said node of said plurality of nodes is capable of generating an output, based at least in part on said input, said output characterized by an output time;
said time windows is selected based at least in part on said input time, said output time, and said reinforcement time; and
integration of said time-dependent function over said window is capable of generating a positive value.

22. A computerized robotic system, comprising:
one or more processors configured to execute computer program modules, wherein execution of the computer program modules causes the one or more processors to implement a spiking neuron network utilizing a reinforcement learning process that is configured to:
determine a performance of said process based at least in part on a process output being generated based on an input; and
based on at least said performance, provide a reinforcement signal to said process, said reinforcement signal configured to cause update of at least one learning parameter associated with said process;
wherein:
said process output is based on a plurality of outputs by a plurality of nodes of the network, individual ones of the plurality of outputs being generated based on at least a part of the input; and
said update is configured based on a comparison of said process output with individual ones of the plurality of outputs.

23. A method of operating a neural network having a plurality of neurons and connections, the method comprising:
operating the network using a first subset of the plurality of neurons and connections in a first learning mode; and
operating the network using a second subset of the plurality of neurons and connections in a second learning mode, the second subset being larger in number than the first subset, the operation of the network using the second subset in a second operating mode increasing the learning rate of the network over operation of the network using the second subset in the first mode.

24. The method of claim 24, wherein the first learning mode comprises a global reinforcement signal, and the second mode comprises a reinforcement signal that is at least in part correlated to the performance of one or more individual neurons of the plurality.

25. The method of claim 24, wherein the second subset comprises a subset of sufficiently large number such that the global reinforcement signal would be substantially unrelated to the performance of any single neuron of the plurality if operated in the first mode.

26. A method of enhancing the learning performance of a neural network having a plurality of neurons, the method comprising attributing one or more reinforcement signals to appropriate individual ones of the plurality of neurons using a prescribed learning rule that accounts for at least an eligibility of the individual ones of the neurons for the reinforcement signals.

27. The method of claim 26, wherein the plurality of neurons is sufficiently large in number such that a global reinforcement signal would be inapplicable to at least a portion of the individual ones of the neurons.

28. Robotic apparatus capable of accelerated learning performance, the apparatus comprising:
a neural network having a plurality of neurons; and
logic in signal communication with the neural network, the logic configured to attribute one or more reinforcement signals to appropriate individual ones of the plurality of neurons of the network using a prescribed learning rule, the rule configured to account for at least an eligibility of the individual ones of the neurons for the reinforcement signals.
